(19) United States
(12) Patent Application Publication
(10) Pub. No.: US 2005/0122648 A1
(43) Pub. Date: Jun. 9, 2005

(54) USB storage device with at least one I/O apparatus

(75) Inventors: Kuo-Hung Wu, Jhonghe City (TW); Chien-Wei Teng, Miaoli City (TW); Hung-Tse Ho, Taipei City (TW)

Correspondence Address: BACON & THOMAS, PLLC, 625 SLATERS LANE, FOURTH FLOOR, ALEXANDRIA, VA, 22314, US

(73) Assignee: C-One Technology Corporation, Hsin-Chu City (TW)

(21) Appl. No.: 10/978,563

(22) Filed: Nov. 2, 2004

(30) Foreign Application Priority Data
Dec. 3, 2003 (TW) 092221316

(51) Int. Cl. H02H 3/00

(52) U.S. Cl. 361/62; 439/610

(57) ABSTRACT

A USB storage device having an I/O apparatus for decreasing the quantity of USB ports to be coupled to is provided. In one embodiment, the USB storage device includes a USB connector adapted to couple to a USB port of a portable electronic device, a memory unit adapted to be a storage device, at least one I/O apparatus adapts to provide at least one I/O function, a bridge, and a USB hub coupled to the USB connector and the memory unit respectively and further coupled to the at least one I/O apparatus via the bridge such that the USB hub adapts to communicate with the memory unit and the at least one I/O apparatus respectively. The bridge adapted to either convert the USB signal from the USB hub into an I/O signal or convert at least one I/O signal into the USB signal.

### BACKGROUND OF THE INVENTION

1. Field of the Invention

The present invention relates to USB storage devices and, more particularly, to such a USB storage device with at least one I/O (input/output) apparatus.

2. Description of Related Art

Currently, the trend of electronic products (e.g., notebook computers, palm computers, PDAs (Personal Digital Assistants), digital still cameras (DSCs), etc.) is towards being light, compact, and portable due to continuous progress in electronics and assembly science. The portable device can provide users with great convenience particularly in an out-of-office operating environment. Typically, such a portable device just provides several basic functionalities due to its compact size. But it provides one or more ports and each port is adapted to couple to a portable electronic device in the shape of card for providing an additional function thereby.

Currently, USB (Universal Serial Bus) ports are widely disposed in such small, portable electronic devices. By configuring as above, the small electronic device may be electrically coupled with a memory card, a modem card, a GPS (Global Positioning System) card or a GPRS (General Packet Radio Service) card so as to enhance the functions of storage, dialing, global positioning and wireless communication respectively. Furthermore, increasing amounts of additional functions are required due to the ever growing applications of the functional module, and in turn, the quantity of memory cards connected thereto is increased. However, the provision of USB ports on the small electronic device is limited due to the small size of device. The USB ports are typically arranged in a row but the space will be very crowded if several cards are plugged in the USB ports. Even worse, some USB ports may be not accessible if one or more relatively large cards are plugged in.

Therefore, it is desirable to provide a USB device with an I/O apparatus so that other extended modules can electrically connect to the I/O apparatus instead of the portable electronic device in order to mitigate and/or obviate the aforementioned problems.

### SUMMARY OF THE INVENTION

To avoid above defects, the present invention provides a USB storage device with at least one I/O apparatus. The USB storage device incorporates at least one I/O apparatus and memory device and therefore provides both characteristics of function extension and data storage, wherein the USB storage device coupled with other electronic devices just plugs into one USB port of the portable electronic device.

The present invention discloses the USB storage device with at least one I/O apparatus comprising: a USB connector adapted to couple to a USB port of an electronic device to obtain a USB signal; a memory unit adapts to be a storage device; at least one I/O apparatus adapted to provide at least one I/O function; a bridge; and a USB hub coupled to the USB connector and the memory unit respectively and further coupled to the at least one I/O apparatus via the bridge such that the USB hub adapts to communicate with the memory unit and the at least one I/O apparatus respectively; wherein the bridge adapts to either convert the USB signal from the USB hub into an I/O signal prior to sending to the at least one I/O apparatus or convert at least one I/O signal from the at least one I/O apparatus into the USB signal.

The present invention discloses the USB storage device with at least one I/O apparatus comprising: a USB connector adapted to couple to a USB port of an electronic device to obtain a USB signal; a memory unit adapted to be a storage device; a connector adapted to couple to an external I/O apparatus; a bridge; and a USB hub coupled to the USB connector and the memory unit respectively such that the USB hub communicates with the memory unit and the external I/O apparatus respectively; wherein the bridge adapts to either convert the USB signal from the USB hub into an I/O signal prior to sending to the external I/O apparatus or convert an I/O signal from the external I/O apparatus into the USB signal.

Other objects, advantages, and novel features of the invention will become more apparent from the detailed description when taken in conjunction with the accompanying drawings.

### BRIEF DESCRIPTION OF THE DRAWINGS

FIG. 1 is a block diagram of a first preferred embodiment of USB storage device according to the invention;

FIG. 2 is a block diagram of a second preferred embodiment of USB storage device according to the invention;

FIG. 3 is a block diagram of a third preferred embodiment of USB storage device according to the invention; and

FIG. 4 is a block diagram of a fourth preferred embodiment of USB storage device according to the invention.

### DETAILED DESCRIPTION OF THE PREFERRED EMBODIMENT

With reference to FIG. 1, there is shown a USB storage device in accordance with a first preferred embodiment of the invention. As shown, the USB storage device comprises a USB connector 11, a USB hub 12, a memory unit 13, a bridge 14, and an I/O apparatus 15. Each component will be described in detail below. The memory unit 13 comprises a memory control 131 and a memory module 132 for storing data. The I/O apparatus 15 is implemented as a Bluetoothor GPRS module for providing an I/O function. The USB connector 11 of the USB storage device is adapted to plug into a USB port of the portable electronic device (not shown), thereby the electronic device can communicate with the USB storage device.

The USB hub 12 is not only coupled to the USB connector 11 and the memory unit 13 respectively, but is also coupled to the bridge 14 which is in turn coupled to the I/O apparatus 15. By configuring as above, signals obtained from the USB connector 11 are output to the memory unit 13 and the I/O apparatus 15 respectively. In other words, both the memory unit 13 and the I/O apparatus 15 share the total bandwidth of the USB communication.

Preferably, the memory module 132 of the memory unit 13 is a flash memory. The memory control 131 accesses the memory module 132 based on the signal received from the portable electronic device via the USB connector 11 and the USB hub 12, therefore either data from the portable electronic device is able to write into the memory unit 13 or the portable electronic device is able to read data from the memory unit 13.

The bridge 14 is adapted to convert a USB signal (e.g., VCC, D+, D−, or GND) from the USB hub 12 into an I/O signal which is in turn sent to the I/O apparatus 15. Alternatively, the bridge 14 is adapted to convert an I/O signal from the I/O apparatus 15 into a USB signal. Preferably, the I/O apparatus 15 is a serial apparatus (e.g., UART (Universal Asynchronous Receiver/Transmitter)). Generally, the I/O apparatus 15 does not provide high-speed data transmission. As such, the I/O apparatus 15 can be implemented as a low speed UART apparatus. It is well known that the low speed I/O apparatus 15 and the memory unit 13 can communicate with the USB hub 12 simultaneously because of the superior bandwidth of the USB communication.

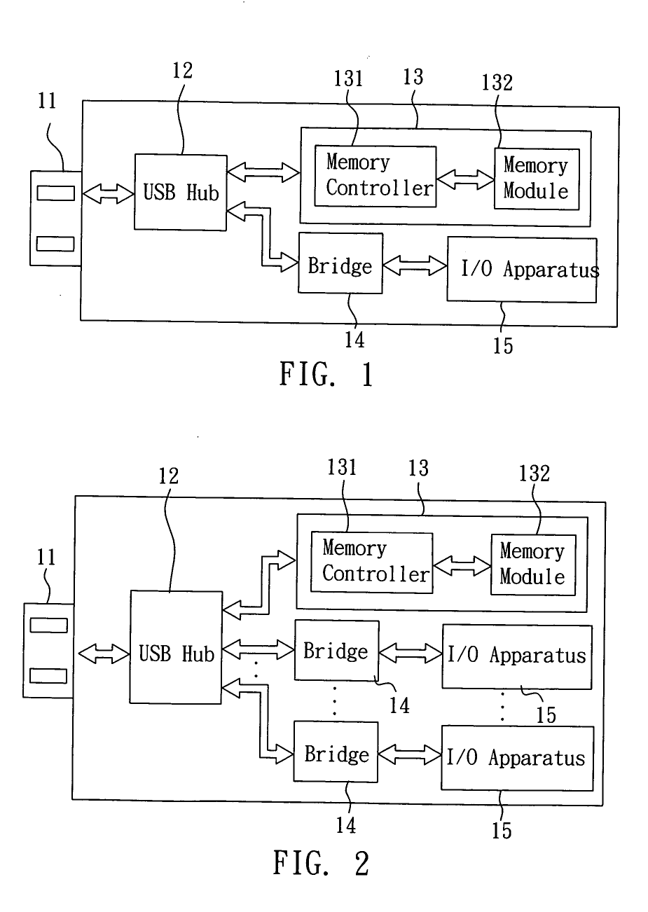

With reference to FIG. 2, there is shown a USB storage device in accordance with a second preferred embodiment of the invention. The second preferred embodiment substantially has a similar structure as the first preferred embodiment. The differences between the first and the second preferred embodiments, i.e., the characteristics of the second preferred embodiment are detailed below. The USB storage device of the second preferred embodiment further comprises a plurality of I/O apparatuses 15 and a plurality of corresponding bridges 14. Each bridge 14 connects to the I/O apparatus 15 and the USB hub 12 respectively. The I/O apparatuses 15 work slowly so that the I/O apparatuses 15 and the memory unit 13 can communicate with the USB hub 12 simultaneously.

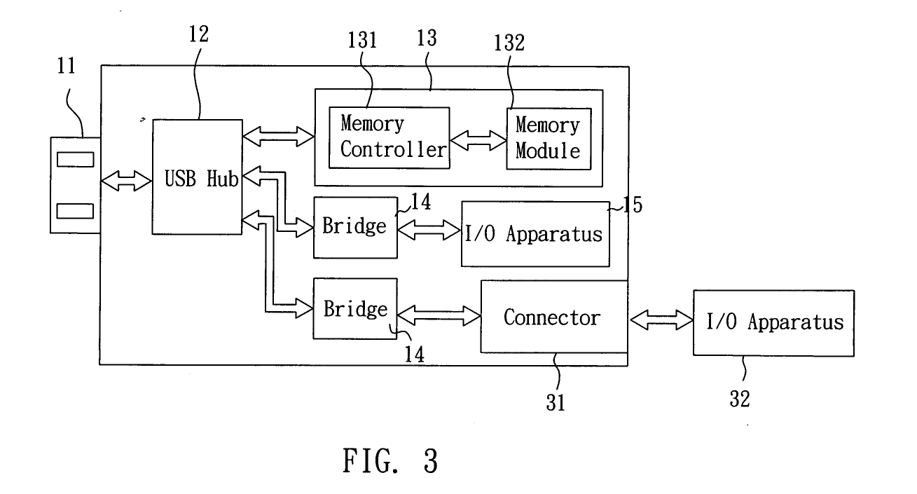

With reference to FIG. 3, there is shown a USB storage device in accordance with a third preferred embodiment of the invention. The third preferred embodiment substantially has a similar structure as the first preferred embodiment. The differences between the first and the third preferred embodiments, i.e., the characteristics of the third preferred embodiment are detailed below. The USB storage device of the third preferred embodiment further comprises a second bridge 14 and a connector 31 adapted to connect with an external I/O apparatus 32. The connector 31 communicates with the USB hub 12 via the second bridges 14. By configuring as above, the second bridge 14 converts a USB signal from the USB hub 12 into an I/O signal which is in turn sent to the I/O apparatus 32 via the connector 31. Alternatively, the second bridge 14 also converts an I/O signal from the I/O apparatus 32 via the connector 31 into a USB signal which is in turn sent to the USB hub 12.

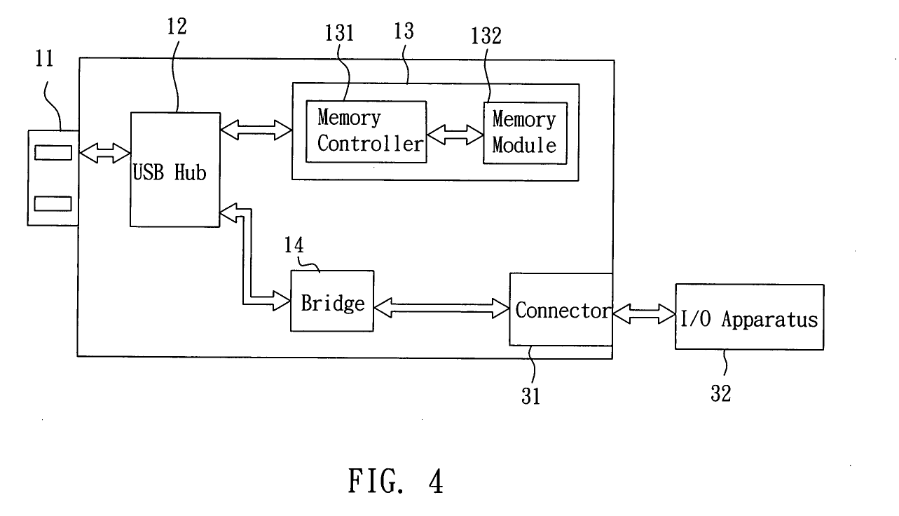

With reference to FIG. 4, there is shown a USB storage device in accordance with a fourth preferred embodiment of the invention. The fourth preferred embodiment substantially has a similar structure as the first preferred embodiment. The differences between the first and the fourth preferred embodiments, i.e., the characteristics of the fourth preferred embodiment are detailed below. In the embodiment, the I/O apparatus 32 is an external device, instead of an internal device. The external I/O apparatus 32 is coupled to a connector 31 of the USB storage device and the connector 31 is in turn coupled to the bridge 14. As such a configuration, the bridge 14 converts the USB signal from the USB hub 12 into an I/O signal which is in turn sent to the I/O apparatus 32 via the connector 31. Alternatively, the bridge 14 also converts an I/O signal from the I/O apparatus 32 via the connector 31 into a USB signal which is in turn sent to the USB hub 12.

In view of the foregoing, it is known that the invention employs a USB hub to communicate with the memory unit and at least one I/O apparatus such that a simultaneous operation of the I/O apparatus and the memory unit is made possible. Hence, by connecting a single USB storage device to a USB port it is possible to expand the storage capability and I/O functions of an electronic device, thereby achieving the purpose of decreasing the quantity of USB ports to be coupled to.

Although the present invention has been explained in relation to its preferred embodiment, it is to be understood that many other possible modifications and variations can be made without departing from the spirit and scope of the invention as hereinafter claimed.

1. A USB storage device with at least one I/O apparatus, comprising:
a USB connector adapted to couple to a USB port of an electronic device to obtain a USB signal;
a memory unit adapted to be a storage device;
at least one I/O apparatus adapted to provide at least one I/O function;
a bridge; and
a USB hub coupled to the USB connector and the memory unit respectively and coupled to the at least one I/O apparatus via the bridge, and the USB hub adapted to communicate with the memory unit and the at least one I/O apparatus respectively;
wherein the bridge is adapted to either convert the USB signal from the USB hub into an I/O signal prior to sending to the at least one I/O apparatus or convert at least one I/O signal from the at least one I/O apparatus into the USB signal.

2. The USB storage device as claimed in claim 1, wherein the memory unit comprises a memory module and a memory control for accessing the memory module based on the USB signal such that either data from the electronic device is adapted to write into the memory unit or the electronic device is adapted to read data from the memory unit.

3. The USB storage device as claimed in claim 2, wherein the memory module is a flash memory.

4. The USB storage device as claimed in claim 1, further comprising a connector and a second bridge, and wherein the connector is adapted to couple to an external I/O apparatus and the USB hub via the second bridge.

5. The USB storage device as claimed in claim 1, wherein the I/O apparatus is a serial apparatus.

6. The USB storage device as claimed in claim 5, wherein the serial apparatus is a UART apparatus.

7. A USB storage device with at least one I/O apparatus, comprising:
a USB connector adapted to couple to a USB port of an electronic device to obtain a USB signal;
a memory unit adapted to be a storage device;
a connector adapted to couple to an external I/O apparatus;
a bridge; and
a USB hub coupled to the USB connector and the memory unit respectively, and the USB hub adapted to communicate with the memory unit and the external I/O apparatus respectively;
wherein the bridge is adapted to either convert the USB signal from the USB hub into an I/O signal prior to sending to the external I/O apparatus or convert an I/O signal from the external I/O apparatus into the USB signal.

8. The USB storage device as claimed in claim 7, wherein the memory unit comprises a memory module and a memory control for accessing the memory module based on the USB signal such that either data from the electronic device is adapted to write into the memory unit or the electronic device is adapted to read data from the memory unit.

9. The USB storage device as claimed in claim 8, wherein the memory module is a flash memory.
